(19) United States
(12) Patent Application Publication
(10) Pub. No.: US 2023/0047952 A1
(43) Pub. Date: Feb. 16, 2023

(54) ASSEMBLY FOR A TURBINE ENGINE

(71) Applicant: SAFRAN AIRCRAFT ENGINES, Paris (FR)

(72) Inventors: Paul Olivier DANRE, MOISSY-CRAMAYEL (FR); Jean-Luc BACHA, MOISSY-CRAMAYEL (FR); Julie Laure Antoinette BUREL, MOISSY-CRAMAYEL (FR); Julien Michel TAMIZIER, MOISSY-CRAMAYEL (FR); Christophe Bernard TEXIER, MOISSY-CRAMAYEL (FR)

(73) Assignee: SAFRAN AIRCRAFT ENGINES, Paris (FR)

(21) Appl. No.: 17/794,107

(22) PCT Filed: Jan. 20, 2021
(86) PCT No.: PCT/EP2021/051142

§ 371 Date: Jul. 20, 2022

(30) Foreign Application Priority Data
Jan. 23, 2020 (FR) FR2000672

(51) Int. Cl. F23R 3/06; F23R 3/60; F01D 9/02

(52) U.S. Cl. CPC F23R 3/06; F01D 9/02; F23R 3/60; F05D 2220/323; F05D 2240/12; F05D 2240/35; F05D 2260/941

(57) ABSTRACT

An assembly for a turbomachine extending along an axis includes a combustion chamber having, at its downstream end, a downstream flange having a radially extending part. The assembly further includes a distributor disposed downstream of the combustion chamber and having a platform from which at least one vane extends radially. The platform includes an upstream flange extending radially and delimiting, with the radial part of the downstream flange disposed opposite it. An annular space for the circulation of cooling air opens into the combustion chamber at its radially internal end and has, at its radially external end, means of sealing attached to the distributor.

### TECHNICAL FIELD OF THE INVENTION

The present invention relates to an assembly for a turbomachine, such as, for instance, an airplane turbojet engine or a turboprop engine.

### Prior Art

Such an assembly is known from FR 3 004 518 in the name of the Applicant and is illustrated in FIGS. 1 to 3. This comprises an annular combustion chamber 1 disposed downstream of a compressor, and upstream of a high pressure turbine inlet distributor 2.

The combustion chamber 1 comprises internal and external walls of revolution, referred to as the internal shroud 3 and external shroud 4 respectively, which extend into each other and are connected upstream to an annular chamber bottom wall 5.

In order to limit the deformation of the internal 3 and external 4 shrouds, the latter are equipped at their downstream end with internal and external flanges 6. Each flange 6 is annular and has a U-shaped or pin-shaped section. Each flange 6 extends radially inwards or outwards and has a radial part 7a attached to the internal shroud 3 or external shroud 4 of the combustion chamber 1. The free end 6a of each flange 6 is furthermore intended to cooperate with an internal housing 8 or an external housing 9 of the chamber 1. An axial or cylindrical part 7b extends downstream from the radial part 7a of the flange 6.

The distributor 2 is attached downstream of the chamber 1 by suitable means and comprises internal 11 and external 12 platforms which are connected by substantially radial vanes 13. The external platform 12 of the distributor 2 is axially aligned with the downstream end part of the external shroud 4 of the chamber 1, and its internal platform 11 is axially aligned with the downstream end part of the internal shroud 3 of the chamber 1. The upstream end of each platform 11, 12 of the distributor 2 has a radial rim 14 which is smaller than the radial part 7a of the corresponding flange 6 of the combustion chamber 1.

A distributor assembly 2 is generally mounted downstream of the combustion chamber 1 and comprises a plurality of distributors 2 whose platforms 11, 12 are ring sectors, the platforms 11, 12 of the distributors 2 being mounted circumferentially end-to-end to create a fluid flow channel downstream of the combustion chamber 1.

The radial parts 7a and the rims 14 delimit, for each shroud 3, 4, an annular space 15 which opens at a radially internal end into the chamber 1 and which is closed at its radially external end by means of sealing 16.

As is best seen in FIGS. 2 and 3, these means of sealing 16 have sealing strips 17 extending radially and circumferentially along each distributor sector 2. Each strip 17 is able to come to bear, in a sealed manner, on a radial face of the corresponding flange 14 of the distributor 2 and on the free end of the axial part 7b of the corresponding flange 6 of the combustion chamber 1. The strips 17 are held in place on the said parts 7b, 14 by means of elastic return means.

These elastic means are, for example, helical springs or spring blades 18, attached by means of screws 19 which are screwed into lugs 20 extending radially from the corresponding shroud 11, 12 of the distributor 2. The downstream parts 21 of the internal and external shrouds 3, 4 can have multi-perforations. During operation of the turbomachine, bypass air 23 flows into the spaces 24 and 25 delimited respectively by the external housing 9 and the external shroud 4 and by the internal housing 8 and the internal shroud 3. This bypass air 23 passes through the multi-perforations, so as to limit the heating of the downstream parts 21 of the internal and external shrouds 3, 4.

During operation, local recirculation of the hot gas flow and poor distribution of the cooling-air flows within the annular space 15 occur, which can lead to premature damage to the flanges 6, in particular to the radial parts 7a of the flanges, and to the platforms 1, 12 of the distributor 2.

The invention more particularly aims at providing a simple, efficient and cost-effective solution to this problem.

### DISCLOSURE OF THE INVENTION

To this end, the invention relates to an assembly for a turbomachine extending around an axis and comprising:
a combustion chamber comprising at its downstream end a downstream flange having a radially extending part,
a distributor disposed downstream of the combustion chamber and having a platform from which at least one vane extends radially, the platform comprising an upstream rim extending radially and delimiting, with the radial part of the flange disposed opposite it, an annular space for the circulation of cooling air opening into the combustion chamber at its radially internal end and having, at its radially external end, means of sealing attached to the distributor, the means of sealing extending, firstly, against the distributor and, secondly, against the flange characterized in that the said rim of the distributor or the said radial part of the flange of the combustion chamber has at least one surface irregularity facing the side of the annular space for the circulation of air, the said surface irregularity being formed by a recess or a protruding zone.

The presence of surface irregularities at certain locations allows for a better distribution of cooling-air flows within the annular space for the circulation of cooling air so as to avoid premature degradation of the combustion chamber flange and the distributor platform. The terms “axial”, “radial” and “circumferential” are defined with respect to the axis of the assembly, which is coincident with the axis of the turbomachine. Furthermore, the terms “upstream” and “downstream” are defined in relation to the direction of gas flow within the turbomachine.

The recess is formed by a localized, recessed zone that does not pass axially through the flange or the upstream rim.

The combustion chamber can have a radially internal annular shroud and a radially external annular shroud, each shroud having a downstream flange, the distributor having a radially internal platform and a radially external platform connected by at least one blade, each platform having an upstream rim disposed opposite the downstream flange of the corresponding shroud.

The radially internal and external shrouds of the combustion chamber can be connected by an annular bottom wall.

The surface irregularity can be formed on each radially internal flange of the shroud and/or on each rim, so as to specifically improve the distribution of cooling-air flows in these zones, which are the zones most affected by risks of damage.

Each rim and/or the downstream flange can have at least one recessed surface irregularity with a radial reference plane passing through it, the said radial reference plane being angularly offset, or not, from a median radial plane passing through a distributor blade extending from the corresponding platform of the distributor.

The recess thus generates a zone of negative pressure in the vicinity of the distributor blade, which tends to bring cooling airflows closer together in the flange zones and rim zones situated circumferentially at the said blade, where the risk of degradation is greater in the absence of such surface irregularity. In other words, such a feature ensures a more even distribution of the cooling-air flow in the aforementioned annular space.

The recess can have a general shape of a part of a sphere or a shape of a part of a spheroid or ellipsoid of revolution. In the case where the recessed zone is generally oblong in shape, the axis of extension of the said recessed zone can be radial or extend circumferentially or tangentially.

In general, whatever the form of implementation envisaged, the positioning of the reference plane in relation to the median radial plane passing through the blade can be dependent on the direction of gyration of the rotor in the turbomachine and the shape of the blade, in particular the leading edge of the blade.

It is recalled that a blade has an upper surface and a lower surface connected upstream by a leading edge and downstream by a trailing edge.

Each rim and/or the flange has at least two projecting surface irregularities situated circumferentially on either side of a radial reference plane, each surface irregularity being circumferentially offset from the said radial reference plane, the said radial reference plane being angularly offset, or not, from a median radial plane passing through a blade of the distributor extending from the corresponding platform of the distributor.

The protruding zones or extra-thick zones generate locally higher pressure zones on either side of the zone facing the distributor blade, thus deflecting flows to force mixing by increasing the volume of local airflow. This also tends to bring cooling airflows closer together in the flange and rim zones situated circumferentially at the said blade, where the risk of degradation is greater in the absence of such surface irregularity. In other words, such a feature ensures a more even distribution of the cooling-air flow in the aforementioned annular space.

Each projecting zone can have a rounded shape. Each projecting zone can have an oblong shape extending along an axis. The said axis of extension of each projecting zone can form an angle with the radial direction. The projecting zones on either side of the reference plane can be inclined to each other and to the radial reference plane and can approach each other in the direction of the blade.

The downstream flange can have at least one orifice for the circulation of cooling air extending at least axially and opening into the said annular air flow space, opposite the corresponding upstream rim.

The air passing through the said orifices can thus impact cool the upstream rim of the distributor platform.

The upstream rim and/or the downstream flange has a recessed surface irregularity situated in a radial reference plane, the said radial reference plane being angularly offset, or not, with respect to a median radial plane passing through the orifice for the circulation of cooling air. The radial plane of reference can coincide with the median radial plane passing through the orifice for the circulation of cooling air.

The recess thus creates a zone of negative pressure opposite the orifice, which ensures a more even distribution of the cooling-air flow in the aforementioned annular space.

The upstream rim and/or the downstream flange can have at least two projecting surface irregularities situated circumferentially on either side of a radial reference plane, each surface irregularity being offset circumferentially with respect to the said radial reference plane, the said radial reference plane being angularly offset, or not, with respect to a median radial plane passing through the orifice for the circulation of cooling air.

The protruding zones generate locally higher pressure zones on either side of the orifice and deflect the flows so as to force mixing by increasing the volume of air circulation locally, thus ensuring a more even distribution of the cooling-air flow in the aforementioned annular space. The means of sealing can have at least one radially and circumferentially extending strip, axially coming to bear on the flange of the combustion chamber and on the upstream rim of the distributor.

The distributor can be annular and can have several adjacent angular sectors distributed around the circumference.

The support of the strip on the flange and on the upstream rim can be an axial support.

The upstream rim can extend radially. The strip can come to bear on a downstream radial face of the upstream rim. The flange can have an axial part, the downstream end of which can form a radial bearing face for supporting the strip.

The invention also relates to a turbomachine having an assembly of the aforementioned type. The invention also relates to an aircraft having a turbomachine of the above type or an assembly of the above type.

### BRIEF DESCRIPTION OF THE FIGURES

FIG. 1 is an axial cross-sectional view of a prior art turbomachinery assembly,

FIG. 2 is a detail view of a part of FIG. 1,

FIG. 3 is a detail view of a part of FIG. 1,

FIG. 4 is a schematic view of a distributor sector,

FIG. 5 is a schematic view of the upstream rim of a distributor sector according to a first embodiment of the invention,

FIG. 6 is a schematic view of the upstream rim of a distributor sector according to a first embodiment of the invention,

FIG. 7 is a schematic view of the upstream rim of a distributor sector according to a first embodiment of the invention,

FIG. 8 is a schematic view of the upstream rim of a distributor sector according to a first embodiment of the invention.

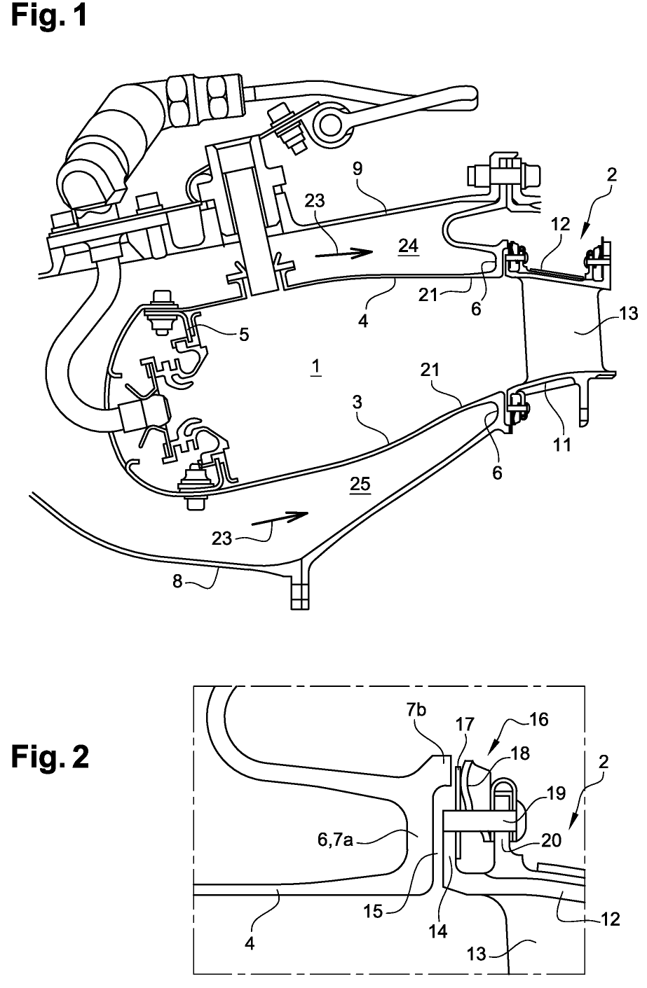

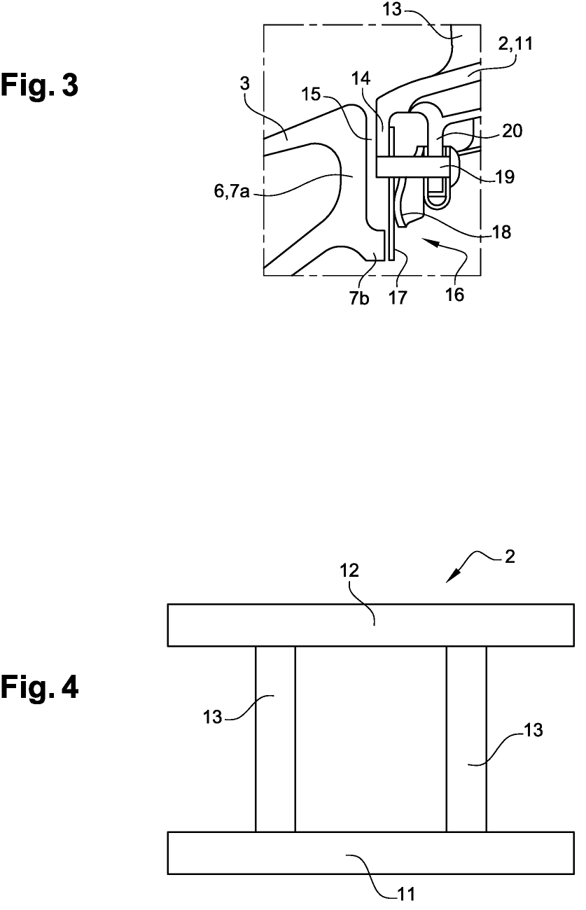

### DETAILED DESCRIPTION OF THE INVENTION

FIG. 4 illustrates an angular distributor sector 2 of an assembly according to the invention. This has a radially internal platform sector 11 and a radially external platform sector 12, connected to each other by radially extending vanes 13, here two vanes 13. Each vane 13 has a lower surface and an upper surface connected to each other upstream by a leading edge and downstream by a trailing edge.

A number of such sectors can be attached adjacent or contiguous to form an annular distributor 2.

In FIG. 4 and the following figures, the platforms 11, 12 are shown in a straight line, although they are actually in the form of ring sectors.

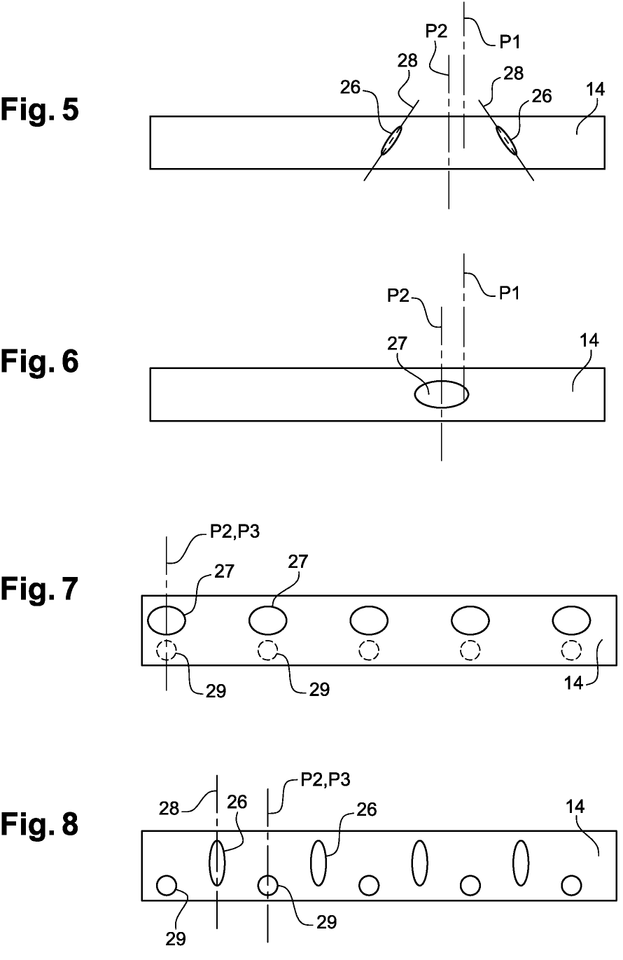

FIG. 4 and following show only the upstream rims 14 of the radially internal platforms 11 of the distributor sectors 2. Each blade 13 extends along a median radial plane P1, the position of which is illustrated by dotted lines in FIGS. 4 and 5.

In the embodiment shown in FIG. 5, the upstream rim 14 has, for each blade 13, two surface irregularities formed by two oblong projecting zones 26 situated on either side of a radial reference plane P2, each surface irregularity 26 being circumferentially offset with respect to the said radial reference plane P2. The radial reference plane P2 is angularly offset, or not, with respect to the median radial plane P1 passing through the corresponding blade 13 of the distributor 2.

The positioning of the reference plane P2 in relation to the median radial plane P1 passing through the blade 13 depends on the direction of gyration of the rotor in the turbomachine and on the shape of the blade 13, in particular the leading edge of the blade 13.

The axis of extension 27 of each projecting zone 26 is at an angle to the radial direction or plane P2. The projecting zones 26 situated on either side of the reference plane P2 are inclined to each other and to the radial reference plane P2 and approach each other in the direction of the blade 13, i.e. upwards in FIG. 5.

Only two projecting zones 26 are shown in FIG. 5. As previously specified, the upstream rim 14 actually has a pair of projecting zones 26 for each blade 13 of the distributor 2.

In operation, the protruding zones 26 locally generate zones of higher pressure on either side of the zone facing the blade 13 of the distributor 2, which tends to bring the cooling-air flows closer together in the zones of the flange 6 and rim 14 circumferentially situated at the level of the said blade 13, where the risks of damage are greater in the absence of such a surface irregularity. In other words, such a feature ensures a more even distribution of the cooling-air flow in the annular space 15 of the cooling-air circulation, situated axially between the corresponding downstream flange 6 of the combustion chamber 1 and the aforementioned upstream rim 14, so as to avoid premature degradation of the flange 6 of the combustion chamber 1 and of the platform 11 of the distributor 2.

FIG. 6 illustrates a further embodiment in which the upstream rim 14 has, for each blade 13, a recessed surface irregularity 27, situated in a radial plane of reference P2. The radial reference plane P2 is angularly offset, or not, with respect to the median radial plane P1 passing through the corresponding blade 13 of the distributor 2.

The recess thus generates a zone of negative pressure in the vicinity of the distributor blade, which tends to bring cooling airflows closer together in the flange zones and rim zones situated circumferentially at the said blade, where the risk of degradation is greater in the absence of such surface irregularity. In other words, such a feature ensures a more even distribution of the cooling-air flow in the aforementioned annular space.

The recess can have a general shape of a part of a sphere or a shape of a part of a spheroid or ellipsoid of revolution. In the case where the recessed zone is generally oblong in shape, the axis of extension of the said recessed zone can be radial or extend circumferentially or tangentially.

FIGS. 7 and 8 illustrate embodiments in which the flange 6 has orifices 29 for the passage of cooling air. The cooling air from the aforementioned orifices 29 cools the corresponding upstream rim 14 of the distributor 2 by impact, but generates heterogeneities in the distribution of the cooling-air flows. The circumferential positions of the orifices 29 are represented by dotted lines in FIGS. 7 and 8.

In order to limit such heterogeneity, in the embodiment shown in FIG. 7, the upstream rim 14 has, for each orifice 29, a recess 27 situated in a radial reference plane P2 which coincides with the median plane P3 passing through the orifice for the circulation of cooling air 29. The impact jet orifice 29 is sized and disposed to cool the upstream rim 14.

The recess thus creates a zone of negative pressure opposite the orifice, which ensures a more even distribution of the cooling-air flow in the aforementioned annular space.

FIG. 8 illustrates an alternative embodiment, which differs from that described with reference to FIG. 7 in that the upstream rim 14 has two projecting surface irregularities 26 each situated in a plane 28 and situated circumferentially on either side of the median plane P3 of each orifice 29.

In other words, the projecting zones 26 are distributed circumferentially between the circumferential positions of the orifices 29.

The protruding zones 26 locally generate zones of higher pressure on either side of the circumferential position of each orifice 29, thus ensuring a more even distribution of the cooling-air flow in the aforementioned annular space 15.

In general, the extra thicknesses or protruding zones 26 direct the cooling flow by deflecting it. The invention thus makes it possible to direct the cooling flow towards the usually hot zones in order to reduce the temperature of the metal. The air is then expelled into the vein by pressure differential from the zone situated outside the said vein into the vein.

In addition, the sub-thicknesses or recesses 27 increase the volume of air circulation and create a local zone of slight negative pressure, drawing in the nearby air. In this way, the zone is locally cooled better because the air is cooler. The air is then expelled into the vein by pressure differential from the zone situated outside the said vein into the vein.

1. An assembly for a turbomachine extending about an axis and comprising:
a combustion chamber comprising, at its downstream end, a downstream flange having a radially extending part , and
a distributor disposed downstream of the combustion chamber and having a platform from which at least one vane extends radially, the platform comprising an upstream rim extending radially and delimiting, with the radial part of the flangedisposed opposite it, an annular space configured for the circulation of cooling air opening into the combustion chamber at its radially internal end and having, at its radially external end, means of sealing attached to the distributor, the means of sealing extending, firstly, against the distributor and, secondly, against the flange wherein the said rimof the distributor or the said radial part of the flange of the combustion chamber has at least one surface irregularity facing the side of the annular spacem for the circulation of air, the said surface irregularity being formed by a recess or a protruding zone .

2. The assembly according to claim 1,
wherein the combustion chamber has an annular radially internal shroud and an annular radially external shroud , each shroud having a downstream flange, the distributor having a radially internal platform and a radially external platform connected by at least one vane, each platform having an upstream rim disposed opposite the downstream flange of the corresponding shroud.

3. The assembly according to claim 2,
wherein the surface irregularity is formed on each flange of the radially internal shroud and/or on each rim.

4. The assembly according to claim 1, wherein each rim and/or each downstream flange has at least one recessed surface irregularity traversed by a radial reference plane (P2), the said radial reference plane (P2) being angularly offset, or not, with respect to a median radial plane (P1) passing through a blade of the distributor extending from the corresponding platform of the distributor.

5. The assembly according to claim 1, wherein each rim and/or the flange has at least two projecting surface irregularitiessituated circumferentially on either side of a radial reference plane (P2), each surface irregularity being offset circumferentially with respect to the said radial reference plane (P2), the said radial reference plane (P2) being angularly offset, or not, with respect to a median radial plane (P1) passing through a distributor blade extending from the corresponding platform of the distributor.

6. The assembly according to claim 1, wherein each flange comprises at least one orifice configured for the circulation of cooling air which extends at least axially and opens into the said annular space for the circulation of air, facing the corresponding rim.

7. The assembly according to claim 6, wherein each rimand/or each flange comprises a recessed surface irregularity situated in a radial reference plane (P2), the said radial reference plane (P2) being angularly offset, or not, with respect to a median radial plane (P3) passing through the orifice for the circulation of cooling air.

8. The assembly according to claim 6 wherein each rim and/or each flange comprises at least two projecting surface irregularities situated circumferentially on either side of a radial plane (P2), each surface irregularity being offset circumferentially with respect to the said radial reference plane (P2), the said radial reference plane (P2) being angularly offset, or not, with respect to a median radial plane (P3) passing through the orifice for the circulation of cooling air.

9. The assembly according to claim 1, wherein the means of sealing comprise at least one strip extending radially and circumferentially, and bearing axially on the flange of the combustion chamber and on the upstream rim of the distributor.

10. A turbomachine comprising at least one assembly according to claim 1.
